(19) United States
(12) Patent Application Publication
(10) Pub. No.: US 2014/0229841 A1
(43) Pub. Date: Aug. 14, 2014

(54) Online Voter Guide

(71) Applicant: YOURVOTERGUIDE, INC., Sacramento, CA (US)

(72) Inventors: Philip Muller, Sacramento, CA (US); Jim Steinwinder, San Jose, CA (US); Nicola Ambroselli, Sacramento, CA (US); Roman Ambroselli, Roseville, CA (US)

(73) Assignee: YOURVOTERGUIDE, INC., Sacramento, CA (US)

(21) Appl. No.: 13/765,615

(22) Filed: Feb. 12, 2013

(51) Int. Cl. G06F 3/0481

(52) U.S. Cl. CPC G06F 3/0481
USPC 715/738

(57) ABSTRACT

Embodiments of system and method are described, the system and method providing election information to a plurality of voters in real time. In particular, the embodiments comprise an address entry page configured as a default start page, an address standardization application programming interface, a voter database, a jurisdictions database containing a list of political jurisdictions, an office database, a candidate database containing names of candidates, a candidate photo database, a measures database, an endorsed measures database, a measures logo database, a polling place database, a mapping application programming interface configured to create an online map and an online voter guide. The system aggregates names of the candidates, offices for which the candidates are running, photographs of the candidates, organizations' positions on ballot measures and the online map into the online voter guide so as to allow the voters to access personalized election information easily in a simple, secure and cost-effective manner.

### BACKGROUND OF THE DISCLOSURE

1. Technical Field of the Disclosure

The present disclosure relates in general to systems and methods for providing election information to a plurality of voters. More specifically, the present disclosure relates to a system and method for providing an enhanced means of delivering election information to a plurality of voters over the Internet.

2. Description of the Related Art

Political systems are complex and multi-layered by design. Federal, state and local political jurisdictions are often gerrymandered to favor one political interest over another. Voters living on one side of a street can live in different political jurisdictions from people living on the other. Voters often join political organizations which exist to represent and protect the interests of the organization's members. However, the complexity of election jurisdictions makes it difficult and expensive for political organizations to provide the members with endorsements specific to their street address. Political organizations often rely on static media such as, direct mail, newspaper advertisements, and political websites to provide regional lists of all their endorsed candidates and recommended positions on ballot measures to the members. Even informed voters find it difficult to determine the political jurisdictions in which they live and the candidates for whom they may vote. This is particularly true in down-ballot, non-partisan, low-information races. The rapid advances in the Internet and electronic mass networking have led to the development of various web-based systems that provide election information to the members.

Some of such conventional systems provide voter information based on voter polling locations proximate to the user. However, a major drawback to this approach is that many polling places serve voters living in more than one precinct. For instance, the voters living in one precinct assigned to a specific polling location may not be voting for the same candidates and ballot measures as voters living in another precinct assigned to the same polling location. Therefore, such voting information systems utilizing polling locations to determine the list of candidates and ballot measures may provide some voters with inaccurate election information. This problem is exacerbated because election officials often change the polling locations for each precinct from one election to another. To date this problem has not been solved.

Another existing system provides voters with lists of all candidates and ballot measures for which they can vote. The system utilizes a database to provide election information such as voter information, candidate submissions, links to candidate websites, party information, campaign information, campaign websites, campaign submissions, regional election overviews, voting machine instructions, and various maps to assist in voting process or described results of the voting process. The downside to these systems is that it is difficult for the voters to determine the list of candidates endorsed by specific political organizations.

There are several other systems developed to provide election information to the voters. Such systems utilize specific databases to store election information. The information is often provided online to voters based upon their polling place. Some other systems utilize a series of online maps to display the polling locations, which in turn requires the voter to visually identify their locations on the maps. In addition to the problems inherent to providing election information based on the polling place, an additional drawback associated with these systems is that they do not provide any means for the voter to determine whether the candidates share the voter's values.

Hence, it can be seen that there is a need for a novel, simple and web-based system to provide election information to the voters based on the jurisdiction of the voters and the political organizations with which the voters associate themselves. Such a system would be designed for each political organization to provide information regarding the endorsed candidates and their recommended positions on ballot measures. Further, the system would provide an online map showing the address entered, address of the polling place and the directions between the two addresses. This system would provide detailed demographic analysis of voter guide users by recording the address entered by voter guide users. In addition, the system would be designed in such a way that it could be implemented successfully in notable web browsers and mobile devices, thereby allowing voters easy access to trustworthy election information in a quick and convenient manner. This unique method described herein overcomes prior art shortcomings by accomplishing these critical objectives.

### SUMMARY OF THE DISCLOSURE

To minimize the limitations found in the prior art, and to minimize other limitations that will be apparent upon the reading of the specification, the preferred embodiment of the present invention provides an improved method for providing election information to a plurality of voters in real time.

The present invention discloses an online system for providing election information to a plurality of voters in real time. The online system in a preferred embodiment comprises an address entry page configured as a default start page, an address standardization application programming interface configured to process addresses entered by the voters, a voter database containing the addresses of the voters and corresponding precinct numbers, a jurisdictions database containing a list of political jurisdictions, an office database containing a list of offices for which there will be candidate elections, a candidate database containing names of the candidates endorsed by the organization and the offices for which the candidates are running, a candidate photo database containing photographs of the candidates endorsed by each organization, a measures database containing the jurisdictions in which measures will be voted upon, an endorsed measures database containing organizations' recommended positions on measures, a measures logo database containing logos of the measures, a polling place database containing a list of locations and addresses of polling places, a mapping application programming interface configured to create an online map and an online voter guide configured to display personalized election information to the plurality of voters. The system aggregates the names of the candidates, offices for which the candidates are running, photographs of the candidates, organizations' positions on ballot measures and the online map into the online voter guide so as to allow the plurality of voters to access personalized election information easily in a simple, secure and cost-effective manner.

In accordance with another aspect of the present invention, a method for providing election information to a plurality of voters in real time is disclosed.

A first objective of the present invention is to provide a web-based system that allows the at least one voter to access a personalized online voter guide easily over the Internet.

A second objective of the present invention is to provide a system for political organizations to inform voters regarding their endorsed candidates and their recommended positions on ballot measures.

A third objective of the present invention is to provide political organizations with detailed demographic analyses of voters who used their voter guides by recording addresses entered by voters.

Another objective of the present invention is to provide an online voter guide designed to be available in an optimized format depending on the electronic device used by the voter.

Yet another objective of the invention is to provide a system that provides an online map indicating the address entered and the address of the polling place to the voters.

Still another objective of the invention is to provide a system designed to be implemented successfully using notable web browsers and mobile devices.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 is a block diagram of an online system for providing election information to a plurality of voters in real time;

FIG. 2 is an operational flow chart of a method for providing election information to a plurality of voters in real time in accordance with the preferred embodiment of the present invention;

FIG. 3 illustrates an address entry page of the online system in accordance with the preferred embodiment of the present invention;

FIG. 4 illustrates the address entry page displaying the address entered by at least one voter in accordance with the preferred embodiment of the present invention; and

FIG. 5 illustrates the online voter guide displaying personalized election information to the plurality of voters in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be addressed fully by any of the features described below. Finally, many of the steps are presented below in an order intended only as an exemplary embodiment. Unless logically required, no step should be assumed to be required earlier in the process than a later step simply because it is written first in this document.

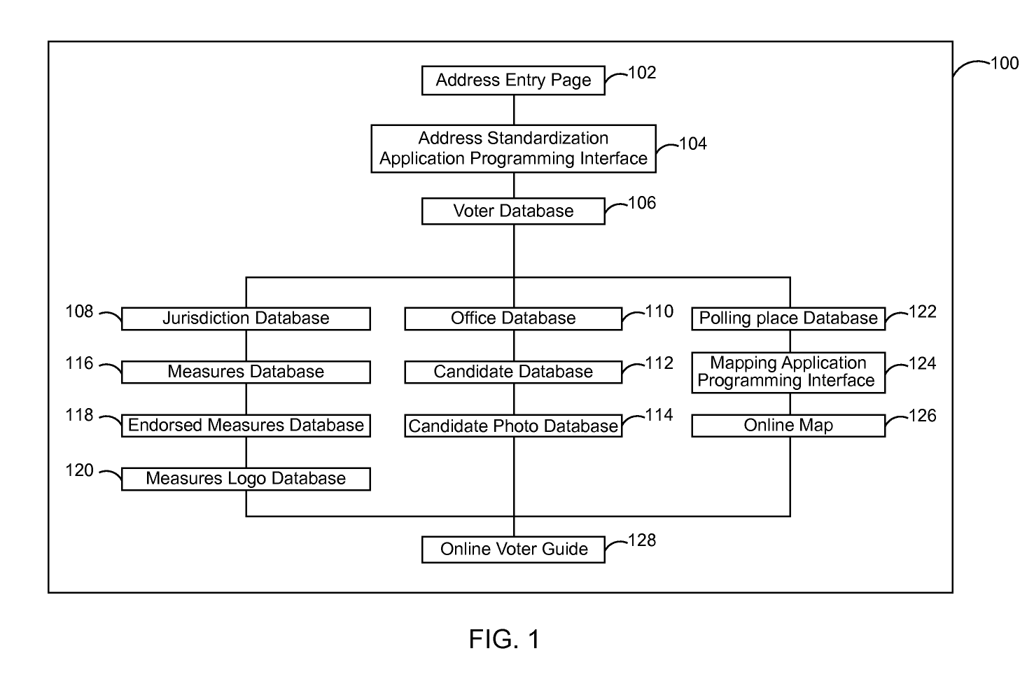

Turning first to FIG. 1, a block diagram of an online system 100 for providing election information to a plurality of voters in real time is illustrated. The online system 100 comprises an address entry page 102 configured as a default start page, an address standardization application programming interface 104 configured to process addresses entered by voters, a voter database 106 containing the addresses of voters and corresponding precinct numbers, a jurisdictions database 108 containing a list of political jurisdictions, an office database 110 containing a list of offices for which there will be candidate elections, a candidate database 112 containing names of the candidates endorsed by the organization and the offices for which the candidates are running, a candidate photo database 114 containing photographs of the candidates endorsed by the organization, a measures database 116 containing the jurisdictions in which measures will be voted upon, an endorsed measures database 118 containing organizations' recommended positions on measures, a measures logo database 120 containing logos of the measures, a polling place database 122 containing a list of locations and addresses of polling places, a mapping application programming interface 124 configured to create an online map 126 and an online voter guide 128 configured to display personalized election information to the plurality of voters. The system 100 aggregates the names of the candidates, offices for which the candidates are running, photographs of the candidates, organizations' positions on ballot measures and the online map 126 into the online voter guide 128 so as to allow the plurality of voters to access personalized election information easily in a simple, secure and cost-effective manner.

In this preferred embodiment, the system 100 is accessed by at least one voter using an electronic device. To access the system 100, the plurality of voters may enter the address in the address entry page 102. The address entered is the address at which the voter is registered to vote. The address entered is matched against the voter database 106 to determine the number of the precinct containing the address. The precinct number is then matched against the jurisdictions database 108, the office database 110, the measures database 116 and the polling place database 122 to determine the offices for which there will be candidate elections, the political jurisdictions in which measures will be voted upon, and the locations and addresses of polling places respectively. The jurisdictions database 108, the measures database 116 and the polling place database 122 group data by unique precinct numbers assigned by election officials. The system 100 creates unique office numbers for political jurisdictions contained in the jurisdictions database 108, the office database 110 and the measures database 116. The system 100 utilizes a software program to aggregate the names and offices of organizations' endorsed candidates, photographs, organizations' positions on ballot measures and the logos of the measures into the online voter guide 128. The online map 126 is designed to display the address entered, the address of the polling place and directions between the address entered and the polling place address.

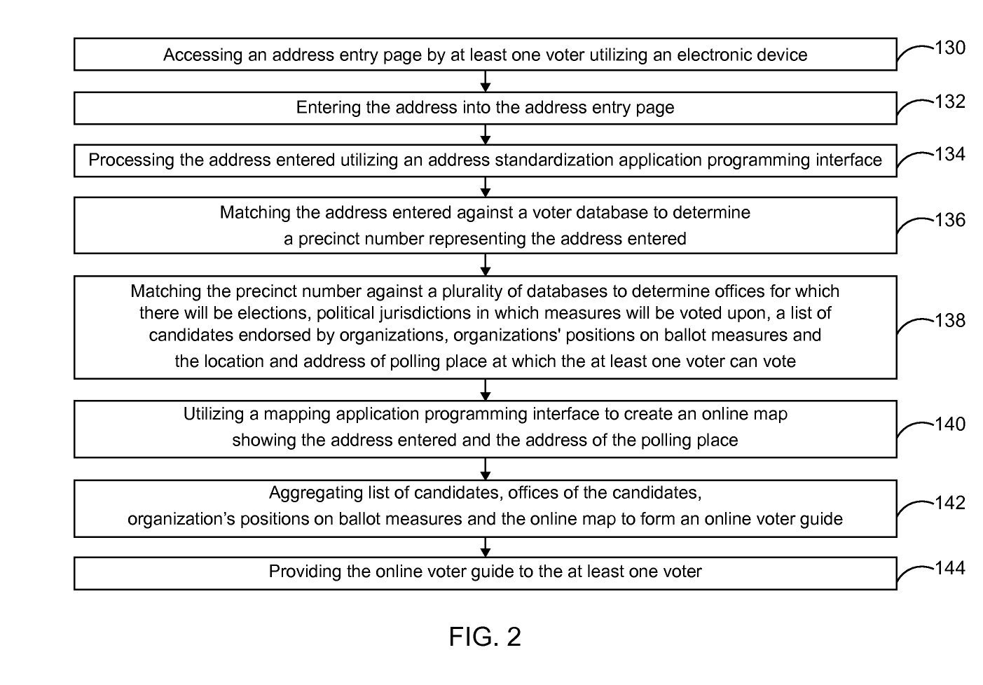

One method of the present invention considers aggregating the names of the candidates, offices for which the candidates are running, photographs of the candidates, organizations' positions on ballot measures and the online map 126 to provide the online voter guide 128 to the plurality of voters. Referring to FIG. 2, an operational flow chart of a method for providing election information to a plurality of voters in real time is illustrated. Initially, the address entry page is accessed by at least one voter utilizing an electronic device as indicated at block 130. Next, a physical address is entered into the address entry page by the at least one voter as shown in block 132. Then, the address entered is processed utilizing an address standardization application programming interface as indicated at block 134. The address entered is matched against a voter database to determine the number of the precinct containing the address entered as shown in block 136. As indicated at block 138, the precinct number is then matched against a plurality of databases to determine offices for which there will be candidate elections, political jurisdictions in which measures will be voted upon, a list of candidates endorsed by organizations, organizations' positions on ballot measures and the location and address of a polling place at which the at least one voter can vote. In next step, a mapping application programming interface is utilized to create an online map showing the address entered and the address of the polling place as shown in block 140. The list of candidates, offices for which the candidates are running, the organization's positions on ballot measures and the online map are aggregated to form an online voter guide as indicated at block 142. Finally, as shown in block 144, the online voter guide is provided to the at least one voter.

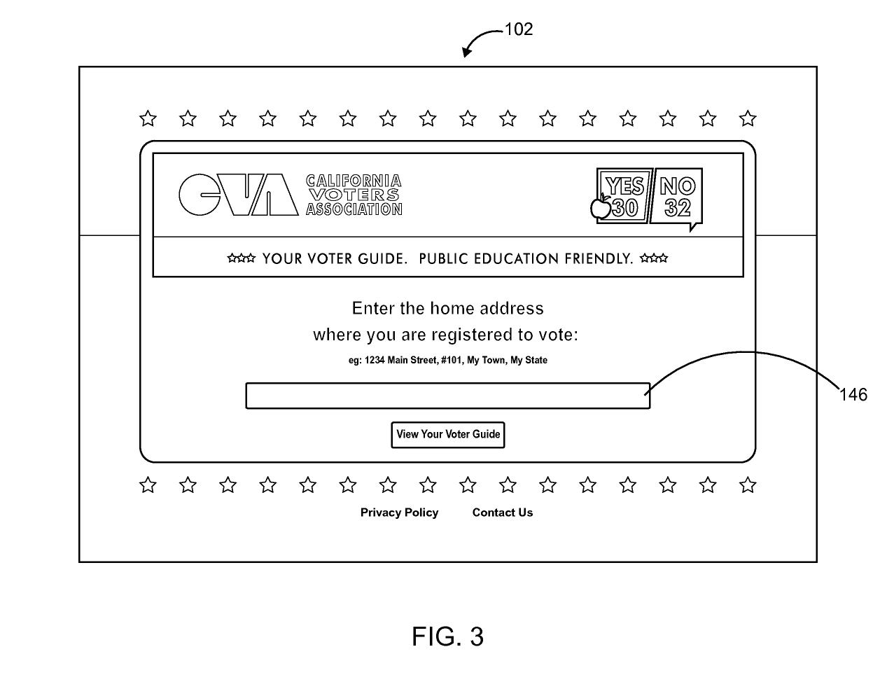

FIG. 3 illustrates the address entry page 102 of the online system 100 in accordance with the preferred embodiment of the present invention. The address entry page 102 is configured to display when the system 100 is launched. To access the system 100, at least one voter may enter the address in an address entry space 146 on the address entry page 102. The at least one voter may access the system 100 using any number of electronic devices, including but not limited to smart phones, tablets, and personal computers.

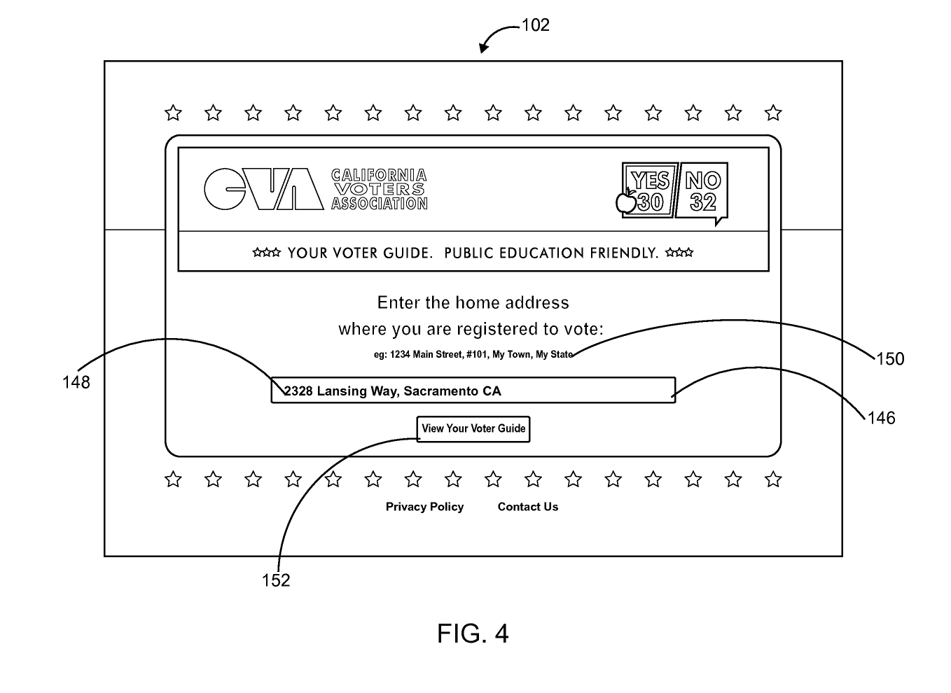

FIG. 4 illustrates the address entry page 102 displaying the address entered 148 by the at least one voter in accordance with the preferred embodiment of the present invention. To access the system 100, the plurality of voters may enter the address 148 in the address entry space 146 on the address entry page 102. The address is required to be entered in a standardized format so the system 100 may process the address. The address entry page 102 displays a sample address format 150 to the voter, who may then enter his or her address into the system 100. After entering the address 148, the at least one voter may click the “View Your Voter Guide” button 152 to access the online voter guide 128. The online voter guide 128 is designed to be implemented in an optimized format depending on the web browser and electronic device used by the at least one voter.

By employing the above-discussed method, political organizations are able to disseminate endorsements specific to voters' addresses over the Internet. The online voter guides are designed for each political organization and contain the political organization's name, copy and design elements. According to this method, the voters receive political information such as recommended candidates and positions on ballot measures from political organizations. Initially, the at least one voter may enter the address in an address entry space 146 on the address entry page 102. The system 100 is provided with voter files from election officials or third parties, which include details on the voters. The system 100 utilizes software programs to extract the addresses of voters against which the addresses produced by the address standardization application programming interface 104 are matched. The address entered by the voter is standardized and matched against the voter database 106 to determine the precinct number containing the address in which the voter resides. The precinct number is then matched to the jurisdiction database 108, the office database 110 and the polling place database 122 to determine the list of offices and ballot measures for which the voter can vote. These databases group their data by unique precinct numbers assigned by election officials. Also, the system 100 creates unique office numbers for political jurisdictions contained in the jurisdictions database 108, the office database 110 and the measures database 116. The system 100 utilizes software programs to convert and standardize data files obtained from election officials or third parties that identify the precincts located in each jurisdiction.

After the system 100 determines in which jurisdictions there will be measure elections, it matches the office number of these jurisdictions to the measures database. The system 100 determines the organization's recommended positions on the various measures from an endorsed measures database. Then, the system 100 matches the organization's recommended positions on the measures to the measures logo database 120. At the same time, the system 100 matches the office number of these jurisdictions to the candidate database 112 containing the names of the organization's recommended candidates for these offices. The system 100 then matches the names of recommended candidates to the candidate photo database 114. Finally, the system 100 matches the precinct number to the polling place database 122. The system 100 utilizes software programs to assemble and standardize polling place location information obtained from election officials or third parties. The system 100 then uses the mapping application programming interface 124 to create the online map 126 indicating the address entered, the address of the polling place as well as at least one route between the address entered and the polling place. The system 100 then utilizes software programs to aggregate the data such as list of candidates, offices for which the candidates are running, organization's positions on ballot measures and the online map to form the online voter guide 128.

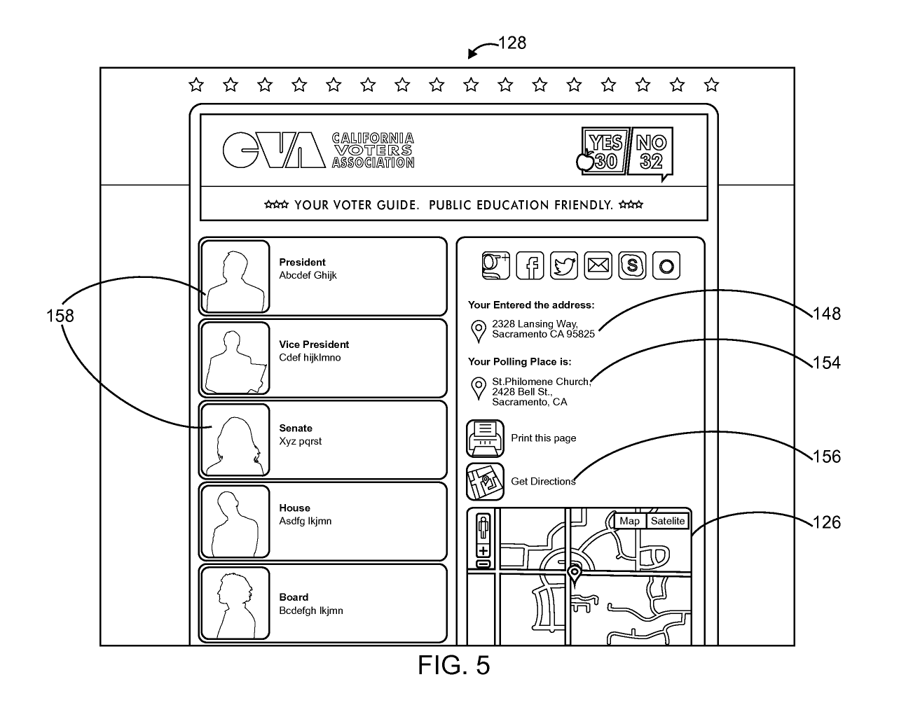

FIG. 5 illustrates the online voter guide 128 displaying personalized election information to the plurality of voters in accordance with the preferred embodiment of the present invention. The online voter guide 128 is designed to be implemented in an optimized format depending on the web browser and electronic device used by the voter. The system 100 determines the type of electronic device the voter is using to access the organization's voter guide and provides a custom online voter guide including the names and photographs of endorsed candidates, offices for which endorsed candidates are running, the organization's positions on ballot measures, the ballot measures' logos and the online map 126. The candidates 158 on the online voter guide 128 are preferably listed in the same order as on the ballot. The online map 126 indicates the address entered 148 and the polling place address 154, thereby allowing voters to determine where they vote or if they live in a mail-ballot precinct. By clicking on the “Get Directions” button 156, the directions between the polling place and the address entered will be displayed to the voter. The system 100 utilizes an application programming interface to provide voters with directions from one address to the other. Thus, the voter can view appropriately formatted online voter guide 128 easily including the names of organizations' endorsed candidates and their recommended positions on ballot measures.

The system 100 allows political organizations to provide personalized election information to voters by means of an online voter guide. The addresses entered by voters are recorded to provide detailed demographic analyses of voter guide users to political organizations. The detailed demographic analysis allows organizations to show members and financial backers how funds were spent. Organizations can also show candidates the number of voters who viewed the organization's endorsements in the candidate's district. By employing the system 100, organizations can have more collective influence over elections, especially those for down-ballot offices and local measures.

The above disclosed system and method allows political organizations to provide personalized online voter guides that perform beyond those in the prior art, and may be designed more simply and potentially more cost-effectively. The system may be designed for each political organization to provide information regarding their endorsed candidates and their recommended positions on ballot measures. In addition, the present invention focuses on an accurate and easy-to-access, web-based system by which election information is provided to voters over the Internet. By providing voters with personalized voter guides, organizations can leverage their influence over elections in local as well as state and federal races. As the voter guides are designed to be optimized for mobile devices, voters can access them conveniently when away from the home or office. The system preferably enables unlimited voter guide views and allows voters to access trustworthy election information in a quick and convenient manner.

The foregoing description of the preferred embodiment of the present invention has been presented for the purpose of illustration and description. It is not intended to be exhaustive or to limit the invention to the precise form disclosed. Many modifications and variations are possible in light of the above teachings. For instance, the appearance of the online voter guide 128 may be different depending on the display and the designing tools of the electronic device used by the voters. It is intended that the scope of the present invention not be limited by this detailed description, but by the claims and the equivalents to the claims appended hereto.

I claim:

1. An online system for providing election information to a plurality of voters in real time, the system comprising:
an address entry page configured as a default start page, the address entry page being configured to display when the system is launched;
an address standardization application programming interface configured to process an address entered by the at least one voter, the address entered being the address at which the at least one voter is registered to vote;
a voter database containing the address data of the at least one voter and a corresponding precinct number;
a jurisdictions database containing a list of political jurisdictions;
an office database containing a list of offices for which there will be candidate elections;
a candidate database containing names of the candidates endorsed by a political organization, the candidate database being further configured to include the offices for which the candidates are running;
a candidate photo database containing photographs of the candidates endorsed by the political organization;
a measures database containing the jurisdictions in which measures will be voted upon;
an endorsed measures database containing the political organizations' recommended positions on the measures;
a measures logo database containing logos of the measures;
a polling place database containing a list of locations and addresses of polling places;
a mapping application programming interface configured to create an online map; and
an online voter guide configured to display personalized election information to the plurality of voters;
whereby the system aggregates the names of the candidates, offices for which candidates are running, photographs of the candidates, the political organizations' positions on ballot measures and the online map into the online voter guide so as to allow the plurality of voters to access personalized election information easily in a simple, secure and cost-effective manner.

2. The system of claim 1 wherein the plurality of voters may enter the address in the address entry page.

3. The system of claim 1 wherein the address entered is matched against the voter database to determine the corresponding precinct number containing the address.

4. The system of claim 3 wherein the precinct number is matched against the jurisdictions database, the office database, the measures database and the polling place database to determine the offices for which there will be elections, the political jurisdictions in which measures will be voted upon, and the locations and addresses of polling places respectively.

5. The system of claim 1 wherein the jurisdictions database, the measures database and the polling place database group data by unique precinct numbers assigned by election officials.

6. The system of claim 1 wherein the system utilizes a software program to aggregate the names and offices of the political organizations' endorsed candidates, photographs, the political organizations' positions on ballot measures and the logos of the measures into the online voter guide.

7. The system of claim 1 wherein the system creates unique office numbers for political jurisdictions contained in the jurisdictions database, the office database and the measures database.

8. The system of claim 1 wherein the online map is designed to display the address entered, the address of the polling place and directions between the address entered and the polling place address.

9. The system of claim 1 wherein the online voter guide includes identifying information regarding ballot measures and the political organization's position on said ballot measures.

10. The system of claim 1 wherein the system is accessed utilizing an electronic device.

11. The system of claim 10 wherein the electronic device may be selected from a group consisting of: smart phones, tablets, and personal computers.

12. The system of claim 1 wherein the online voter guide is designed to be implemented in an optimized format depending on the web browser and electronic device used by the voters.

13. The system of claim 1 wherein the candidates on the online voter guide are listed in the same order as on the ballot.

14. The system of claim 1 wherein the address entered by the voters is recorded to provide detailed demographic analyses of voters to the political organizations.

15. A method for providing election information to a plurality of voters in real time, the method comprising the steps of:
a) accessing an address entry page by at least one voter utilizing an electronic device;
b) entering the address into the address entry page, the address representing the address at which the at least one voter is registered to vote;
c) processing the address entered utilizing an address standardization application programming interface;
d) matching the address entered against a voter database to determine a precinct number containing the address entered;
e) matching the precinct number against a plurality of databases to determine offices for which there will be elections, political jurisdictions in which measures will be voted upon, a list of candidates endorsed by organizations, the organizations' positions on ballot measures and the location and address of polling places at which the at least one voter can vote;
f) utilizing a mapping application programming interface to create an online map showing the address entered and the address of the polling place;
g) aggregating the list of endorsed candidates, offices for which the candidates are running, the organizations' positions on ballot measures and the online map to form an online voter guide; and
h) providing the online voter guide to the at least one voter.

16. The method of claim 15 wherein step (g) further comprises: utilizing a software program to aggregate the list of endorsed candidates, offices for which the candidates are running, organizations' positions on ballot measures and the online map to form the online voter guide.

17. The method of claim 15 wherein the plurality of databases includes a jurisdictions database, an office database, a candidate database, an endorsed measures database and a polling place database.

18. The method of claim 15 wherein the jurisdictions database, the measures database and the polling place database group data by unique precinct numbers assigned by election officials.

19. The method of claim 15 wherein the online map provides directions between the address entered and the polling place address.

20. The method of claim 15 wherein the online voter guide includes identifying information regarding ballot measures and the organization's positions on said ballot measures.

21. The method of claim 15 wherein the online voter guide is designed to be implemented in an optimized format depending on the web browser and electronic device used by the voter.

22. The method of claim 15 wherein the method allows political organizations to provide personalized election information to the at least one voter by means of the online voter guide.

23. The method of claim 15 wherein the electronic device may be selected from a group consisting of: smart phones, tablets, and personal computers.

24. The method of claim 15 wherein the candidates in the online voter guide are listed in the same order as on the ballot.

25. The method of claim 15 wherein the address entered by the voters is recorded to provide detailed demographic analyses of voters to the political organizations.
